(19) United States
(12) Patent Application Publication
(10) Pub. No.: US 2009/0297868 A1
(43) Pub. Date: Dec. 3, 2009

(54) Method for Forming Self-Assembled Monolayer Film, and Structural Body and Field-Effect Transistor Having Same

(75) Inventors: Yutaka Ito, Tokyo (JP); Zhenan Bao, Stanford, CA (US); Jason Locklin, Bogart, GA (US)

Correspondence Address: SQUIRE, SANDERS & DEMPSEY L.L.P., 1 MARITIME PLAZA, SUITE 300, SAN FRANCISCO, CA, 94111, US

(73) Assignees: Toppan Printing Co., Ltd., Tokyo (JP); The Board of Trustees of the Leland Stanford Junior University, Palo Alto, CA (US)

(21) Appl. No.: 12/127,605

(22) Filed: May 27, 2008

(51) Int. Cl. B05D 3/12; B05D 3/02; B32B 9/04

(52) U.S. Cl. 428/447; 427/384; 427/301; 427/240

(57) ABSTRACT

A method for forming a self-organized monomolecular film, including at least: dissolving an alkylsilane compound having at least an alkoxysilane group or a chlorosilane group at one end of a molecule in an organic solvent having a dielectric constant of 3.0 or more to 6.0 or less to obtain a solution; subsequently coating the solution on a base material or immersing the base material into the solution; and subsequently drying the solution located on the base material.

### BACKGROUND OF THE INVENTION

1. Field of the Invention

The present invention relates to a method for forming a self-assembled monolayer film. Further, the present invention relates to a structural body having a self-assembled monolayer film formed by the method for forming a self-assembled monolayer film and to a field-effect transistor in which a self-assembled monolayer film formed by the method for forming a self-assembled monolayer film is provided on the surface of an insulating layer.

2. Description of the Related Art

In recent years, a drive method of an active matrix type that uses a thin-film transistor (TFT) as a display switching element has been employed in a large number of display devices that have come into general use, such as liquid crystal displays, organic electroluminescence (EL) displays, and electrophoretic displays. Field-effect transistors (FET) comprising a gate electrode, a gate insulating layer, source-drain electrodes, and a semiconductor arranged between the source-drain electrodes have been widely used as thin-film transistors serving as such display switching elements. The operation principle of a FET is based on applying a voltage to the gate electrode, thereby controlling the mobility of electric charges including electrons or holes located in the semiconductor, and controlling the conduction of electric charges between the source and drain, that is, the electric current. Based on this action, the transistor acts as a switch.

Amorphous or polycrystalline thin-film silicon has been conventionally used as a semiconductor material for the above-described FET. A process for forming layers of a FET using thin-film silicon, not only the semiconductor, but also electrodes and insulating layer, is typically a vacuum process, and this process requires a high temperature of 300° C. or higher. In addition, photolithography is used for patterning, making it a comparatively complex and costly process.

By contrast, in recent years, it was suggested to use materials that can be dissolved or dispersed in a solvent such as solution-dispersed metal nanoparticles for the electrode material, organic semiconductors for the semiconductor, and organic polymers for the insulating material, and a large number of methods using coating systems such as ink jet, spin coat, or flexo printing have been reported. As a result, it was possible to decrease the temperature, raise the speed, and reduce the cost, of the process.

A FET using an organic semiconductor for the semiconductor is typically called an organic FET. Most of such organic FET have been reported to use silicon oxide obtained by thermal oxidation of silicon as an insulating layer. However, such silicon oxide film cannot by itself sufficiently bring out the charge transfer performance of organic semiconductors, and in most cases the silicon oxide film is used after the surface thereof has been rendered water repellent by treatment with hexamethyldisilazane (HMDS) (J. Am. Chem. Soc. 127, 11542 (2005)) or octadecyltrichlorosilane (OTS) (Appl. Phys. Lett. 81, 268 (2002)).

Such surface treatment demonstrates an effect of modifying hydroxyl groups present on the silicon oxide film surface to prevent them from serving as traps for charge transfer and also an effect of decreasing the surface energy of the insulating layer. As a result, an effect is produced on crystal growth of the semiconductor provided on top of the silicon oxide film, the crystallinity of the semiconductor is improved, and a comparatively high charge carrier mobility is obtained.

However, the surface treatment using the aforementioned HMDS or OTS has to be handled very carefully, and where these compounds aggregate or polymerize on the insulating layer surface, fine particles are deposited on the insulating layer surface and surface roughness increases. As a result, when semiconductor crystals are grown on the interface of the insulating layer and semiconductor, these fine particles serve as nuclei and polycrystals with large crystal grain boundaries, that is, poor charge transfer ability, are produced or the charge carrier transfer is degraded by peaks and valleys present on the surface (Appl. Phys. Lett. 85, 4400 (2004)). For this reasons, HMDS or OTS are usually deposited by a vacuum process to obtain a smooth insulating layer surface.

In this case, the arithmetical mean roughness Ra or square mean roughness RMS of the insulating layer surface at which a comparatively good charge carrier mobility can be obtained is 0.1-0.3 nm. Further, in this case, the surface energy becomes sufficiently low and a contact angle with pure water is about 100 degrees.

The OTS treatment is generally performed on a silicon oxide film that was made hydrophilic by UV/ozone or oxygen plasma treatment. Further, in addition to a vacuum vapor deposition method employing OTS vapor in vacuum, the OTS treatment can be performed using a method of immersing in an OTS solution to obtain a monomolecular film of OTS. With the OTS solution that forms a deposit in the solution, silane groups of OTS usually participate in a hydrolysis reaction with water contained in the system. As a result, as described above, a polymer or oligomer of OTS is produced, and the monolayer film becomes a film with a comparatively large number of peaks and valleys.

As an exception, as described in Langmuir 19, 1159 (2003), OTS deposited under extremely dry conditions has been reported to produce a monolayer film with excellent smoothness. However, a period of 48 h or longer, which is too long for practical use, is required to obtain a monolayer film by such method. Further, it is well known that a comparatively smooth surface can be obtained by depositing OTS in a gas phase, but partial pressure or temperature and water fraction in the system are difficult to control, and additional advancement in technology is needed to obtain monomolecular films with good reproducibility.

Among the above-described methods, a method described in J. Phys. Chem. B110, 21101 (2006) that was published by Nie et al. in 2006 excels in obtaining an extremely smooth self-assembled monolayer film on alumina by dissolving octadecylphosphonic acid in trichloroethylene and spin coating. However, although this method enables the formation of a self-assembled monolayer film on a silicon oxide film which is more versatile than alumina, it cannot provide covalent bonds between the substrate and molecules of the monolayer film. As a result, the monolayer film obtained can be easily washed out with water or the like.

Further, an alkylphosphonic acid used in this method is by itself not a very typical compound and is more difficult to procure than alkylsilane compounds such as OTS. Accordingly, there is a need for a method for forming a self-assembled monolayer film that can form the film from a more typical material that is easy to procure, can form the film within a short interval, without using vacuum or high temperature, and has good reproducibility.

It is an object of the present invention to provide a method for forming a self-assembled monolayer film that can form the film from a more typical material that is easy to procure, can form the film within a short interval, without using vacuum or high temperature, and has good reproducibility. Another object is to provide a field-effect transistor with improved charge transfer performance by providing a self-assembled monolayer film obtained by this method on the surface of an insulating layer.

### SUMMARY OF THE INVENTION

One gist of the present invention resides in a method for forming a self-assembled monolayer film, including at least: dissolving an alkylsilane compound having at least an alkoxysilane group or a chlorosilane group at one end of a molecule in an organic solvent having a dielectric constant of 3.0 or more to 6.0 or less to obtain a solution; subsequently coating the solution on a substrate or immersing the substrate into the solution; and subsequently drying the solution located on the substrate.

Another gist of the present invention resides in a structural body having a self-assembled monolayer film formed by the method for forming a self-assembled monolayer film in accordance with the present invention.

Another gist of the present invention resides in a field-effect transistor in which a self-assembled monolayer film formed by the method for forming a self-assembled monolayer film in accordance with the present invention is provided on the surface of an insulating layer.

### BRIEF DESCRIPTION OF THE DRAWINGS

FIGS. 1A, B, C illustrates part of the mechanism for forming a self-assembled monolayer film in accordance with the present invention.

FIG. 2 illustrates in a simple scheme of a reaction generating covalent bonds between a self-assembled monolayer film of an alkoxysilane compound in accordance with the present invention and a hydrophilic substrate.

FIG. 3 is an example of a basic cross-sectional structure of the field-effect transistor in accordance with the present invention.

FIG. 4 is an example of a basic cross-sectional structure of the field-effect transistor in accordance with the present invention.

### DETAILED DESCRIPTION OF THE INVENTION

Embodiments of the present invention will be described below in greater detail. An alkylsilane compound having at least an alkoxysilane group or a chlorosilane group at one end of a molecule that can be used in accordance with the present invention has a structure represented by Chemical Formula 1.

R1 Si X1 X2 X3 (Chemical Formula 1)

In Chemical Formula 1, R1 is a substituent with two or more carbon atoms that independently includes at least any one from an alkyl group, a phenyl group, a phenoxy group, a thiophene group, a pyrrole group, a pyridine group, a fluorene group, an ether group, an ethylene group, and an acetylene group. More preferably, it is a substituent having 10 or more carbon atoms in an alkyl chain, more specifically a substituent in which the alkyl chain length is equal to or more than 12 Å. Further, preferably the alkyl chain length of the substituent is 30 Å or less.

Where the number of carbon atoms in an alkyl chain is 10 or more, the alkyl chain length is equal to or more than 12 Å, and where the alkyl chain length is equal to or more than 12 Å, a self-organized monomolecular film is formed in which alkyl chains are arranged with good regularity and a pseudocrystal phase that spreads two-dimensionally is obtained. Such effect has also been examined in details and observed in a self-assembled monolayer film of an alkanethiol formed on gold. In the case of alkanethiols, the necessary number of carbon atoms is taken to be 11 or more (Adv. Mater. 8, 719 (1996)). Further, where the alkyl chain length exceeds 30 Å, the roll-back of the alkyl chains becomes predominant. As a result, the alkyl chain cannot maintain a linear shape and a self-assembled monolayer film having an ordered arrangement structure is difficult to obtain.

The alkyl chains as referred to herein include those with single bonds, double bonds, and triple bonds. Suitable examples include alkyl groups having 9 or more carbon atoms, such as a decyl group, an undecyl group, a dodecyl group, a hexadecyl group, an octadecyl group, and a docosyl group, alkyl groups substituted at the end thereof with a phenyl group, a phenoxy group, a thiophene ring, a pyrozine ring, a pyrrole ring, and a fluorene ring, alkyl groups containing in a carbon chain an ether group such as a ter-phenyl group, a quater-phenyl group, and a 3,6,9-oxyundecyl group, and alkyl groups substituted at the end thereof with a vinyl group or an acetylene group.

In Chemical Formula 1, X1, X2, and X3, which are substituents of the silane group, may be all identical, or any one or all of them may be different substituents, but at least one of them is an alkoxy group or a chloro group. The alkoxy group is preferably a methoxy group or an ethoxy group. Among X1, X2, and X3, a methyl group, an ethyl group, an isopropyl group, and a tert-butyl group can be used as a substituent that is not an alkoxy group or a chloro group.

Where the substitution is made with reactive substituents such as an alkoxy group or a chloro group, the silane group acts as a highly polar substituent or is fixed to the substrate by a hydrolysis reaction. In order to increase the silane group polarity with respect to the alkyl chain R1, a methoxy group, an ethoxy group, an isopropoxy group, and a tert-butoxy group are especially preferred as the alkoxy group, and a methoxy group and an ethoxy group are even more preferred.

For example, all of X1, X2, and X3 are identical and selected from trichlorosilane, trimethoxysilane, and triethoxysilane. Alternatively, in order to prevent polymerization, one of them may be a reactive substituent and the remaining two may be nonreactive substituents. For example, chlorodimethylsilane or methoxydiethylsilane can be selected.

Examples of especially preferred alkylsilane compounds include octadecyltrichlorosilane and octadecyltrimethoxysilane.

Octadecyltrichlorosilane and octadecyltrimethoxysilane are very typical compounds that are easy to procure, and the method in accordance with the present invention makes it possible to obtain self-organized monomolecular films of these compounds that have a pseudocrystal phase with especially good stability.

The organic solvent with a dielectric constant of 3.0 or more to 6.0 or less that is used in accordance with the present invention is preferably an organic solvent other than water or alcohols because the alkylsilane compound that is to be dissolved therein has high reactivity with water and alcohols. For the same reason, it is preferred to avoid using solvents with high affinity for water that easily absorb moisture, and solvents with low affinity for a substrate are even more preferred.

It is more preferred that an organic solvent with a dielectric constant of 3.0 or more to 5.0 or less is used. More specifically, trichloroethylene, chloroform, chlorobenzene, anisole, and diethylether can be used.

A solution of the alkylsilane compound is produced by using these organic solvents; it is preferred that the concentration of solution is selected within a range from 1 mmol/L to 10 mmol/L, depending on the alkylsilane compound used. Where the solution concentration is too low, the substrate surface sometimes cannot be completely covered with the alkylsilane compound. Therefore, an optimum concentration has to be found for a specific material used. Where the substrate surface has been completely covered can be determined by observations using an atomic force microscope (AFM).

Examples of substrates that can be used in accordance with the present invention include inorganic materials such as metal oxides, e.g. SiO₂, TiO₂, Al₂O₃, and ITO (tin-doped indium oxide), metal nitrides, and metal oxynitrides. These substrates can be arranged as a thin film on the entire outermost surface of glass, a plastic film, a ceramic material, a metal, or a semiconductor substrate such as a silicon wafer, or on part thereof.

Other examples of substrates include organic materials such as polyvinylphenol (PVP), polystyrene (PS), polymethyl methacrylate (PMMA), polyvinyl alcohol (PVA), polyvinyl chloride (PVC), polyvinylidene fluoride (PVDF), polytetrafluoroethylene (PTFE), polyimides (PI), epoxy resins, polydimethylsiloxane (PDMS), and butadiene rubbers. These substrates can be arranged as a thin film on the entire outermost surface of glass, a plastic film, a ceramic material, a metal, or a semiconductor substrate such as a silicon wafer, or on part thereof. Further, the above-described inorganic materials or organic base materials may be used in the form of a stack or laminate.

It is preferred that the surface of these substrates is as hydrophilic as possible. More specifically, it is preferred that a contact angle with pure water is 10° or less. In order to obtain high hydrophilicity, the surface can be subjected to a hydrophilization treatment such as washing with an acid or base solution, irradiation with plasma of oxygen, nitrogen, or the like, UV/ozone cleaning, or corona discharge cleaning. The substrate surface is thoroughly washed to avoid adhesion of oils and fats, finally washed with a flow of pure water, and dried by blowing dry air or nitrogen.

The method for forming a self-assembled monolayer film in accordance with the present invention includes a first step of dissolving an alkylsilane compound having at least an alkoxysilane group or a chlorosilane group at one end of a molecule in an organic solvent having a dielectric constant of 3.0 or more to 6.0 or less to obtain a solution, a second step of coating the solution on a substrate or immersing the substrate into the solution, and a third step of drying the solution located on the substrate.

The drying as referred to in the description of the present invention indicates a process of evaporating a solvent from a solution and leaving a solute on the substrate at room temperature rather than heating. For example, drying under wind pressure corresponds thereto.

As the concentration of solvent rises in the drying process, the thickness of the self-assembled monolayer film obtained can vary depending on a location on the base material and the orderly arranged structure can become heterogeneous. Therefore, it is preferred that the drying is performed within a short period for example, within 10 sec, preferably within 5 sec after the drying process has been started. Further, the film thickness of the self-assembled monolayer film obtained by the method in accordance with the present invention depends on the solution concentration.

A spin coating method in which coating and drying are carried out by rotation and drying is performed instantaneously after coating is the best method for coating and drying the solution, but this method is not limiting, and it is also possible to spread and cover the solution of the entire base material surface by an appropriate method such as microgravure coating, wire bar coating, or die coating and then rotate the substrate, or the surface may be dried by using a method of blowing dry air, nitrogen, or the like.

In this process, air or nitrogen may be blown from one direction onto the substrate to prevent liquid droplets from sticking to the dried surface. In particular, when a methoxysilane compound or an ethoxysilane compound, which does not have a very high reactivity, is used, where liquid droplets fall after drying has been completed, the self-assembled monolayer thin film will be destroyed in the locations thereof and the desired self-assembled monolayer film will not be obtained. For this reason, drying by spin coating, which causes no such concerns, is the simplest and most reliable method. When spin coating is used, spinning may be performed after the solution has been coated on the substrate, or the solution may be coated on the spinning substrate.

On the other hand, examples of methods by which the substrate is immersed into a solution and dried to obtain a self-assembled monolayer film include a method by which the substrate pulled up from the solvent is rotated and a method by which dried air or nitrogen is blown to dry the surface. In this case, too, gas has to be blown to prevent liquid droplets from adhering to the dried surface.

The formation mechanism of the self-assembled monolayer film obtained by the formation method in accordance with the present invention can be explained in the same manner as explained in J. Phys. Chem. B110, 21101 (2006). In other words, when a solution obtained by dissolving an alkylsilane compound in an organic solvent with a dielectric constant of 3.0 or more to 6.0 or less is coated on a hydrophilic base material, at the substrate—solution interface, the polar side (hydrophilic side) of the alkylsilane compound is oriented toward the substrate, whereas a non-polar side (hydrophobic side) is oriented toward the solution, thereby forming a self-assembled monolayer film.

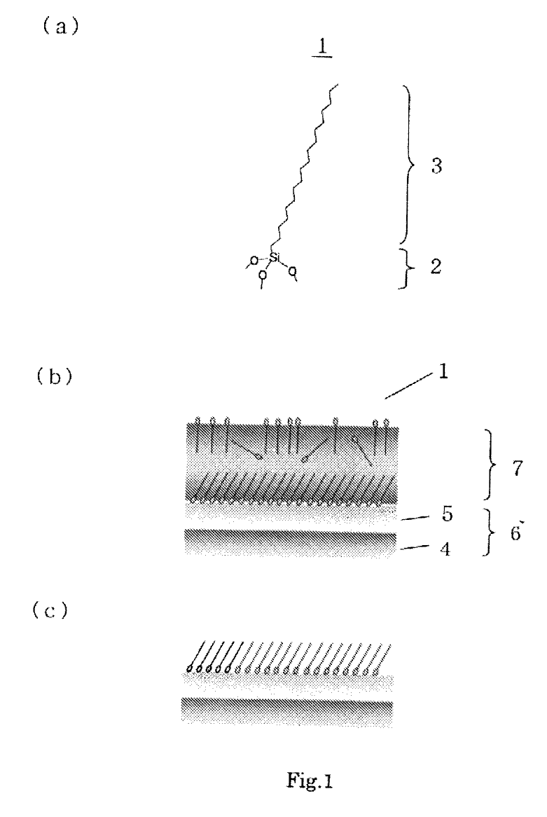

With the alkylsilane compound used in accordance with the present invention, the self-assembled monolayer film is formed because the alkoxysilane group or chlorosilane group acts as a polar group. FIG. 1 shows parts (FIGS. 1B, 1C) of a formation mechanism of a self-assembled monolayer film in the case where octadecyltrimethoxysilane 1 (FIG. 1A) is used.

When a non-polar (hydrophobic) solution 7 obtained by dissolving octadecyltrimethoxysilane 1 in an organic solvent with a dielectric constant of 3.0 or more to 6.0 or less is coated on a substrate 6 in which polar (hydrophilic) silicon oxide (SiO₂) 5 is laminated on silicon (Si) 4, at the interface of the substrate 6 and solution 7, the polar side (hydrophilic side) 2 of octadecyltrimethoxysilane 1 is oriented toward the substrate 6, and a non-polar side (hydrophobic side) 3 is oriented toward the solution 7 (FIG. 1B).

By rotating the base material 6 and drying, the orientations are arranged as shown in FIG. 1C and a self-assembled monolayer film is formed.

Here, when an alkylsilane compound having a chlorosilane group is used, because of a high reactivity thereof, once the chlorosilane group reaches the substrate 6, a hydrolysis reaction is rapidly advanced. Therefore, as the self-assembled monolayer film is being formed during coating or immersing, covalent bonds are generated between the substrate and alkoxysilane compound and the self-assembled monolayer film is tightly bonded to the substrate.

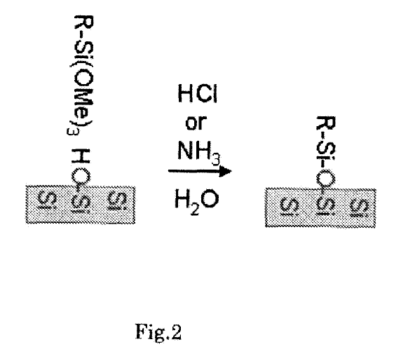

On the other hand, when an alkylsilane compound having an alkoxysilane group is used, because the reactivity of alkoxysilane groups is low, the self-assembled monolayer film is formed, while no covalent bonds with the substrate are generated during coating or immersing, or immediately thereafter. As a result, where the film is brought into contact with water or an organic solvent before the covalent bonds are formed, the self-assembled monolayer film is peeled off from the substrate. Accordingly, when an alkylsilane compound having an alkoxysilane group is used, it is preferred that the hydrolysis reaction is advanced by exposing to a gas such as vapors of an acidic or basic gas after the self-assembled monolayer film has been formed, thereby generating covalent bonds with the substrate (FIG. 2).

Vapors of hydrochloric acid (HCl), sulfuric acid, or nitric acid can be used as the acidic gas employed herein. Vapors of ammonium hydroxide or ammonia (NH₃) can be used as the basic gas. It is preferred that after covalent bonds have been formed between the alkylsilane compound and substrate, the obtained substrate surface is washed with an organic solvent such as toluene or pure water and it is even more preferred that ultrasonic washing is performed in these solvents.

An embodiment of a field-effect transistor in which the self-assembled monolayer film formed by the formation method in accordance with the present invention is provided on the surface of an insulating layer will be described below. In this case, the insulating layer is equivalent to the above-described substrate. Further, in the present embodiment, an example is considered in which the self-assembled monolayer film is provided on the surface of a gate insulating layer, but such configuration is not limiting.

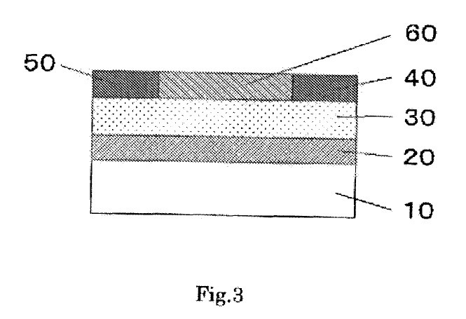

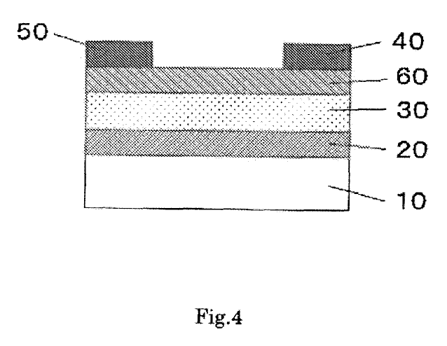

FIG. 3 and FIG. 4 show an example of a basic structure of the field-effect transistor in accordance with the present invention. The structure shown in FIG. 3 is called a bottom-gate and bottom-contact structure, and that shown in FIG. 4 is called a bottom-gate and top-contact structure.

Any substrate can be used as an insulating substrate 10, provided that it has an electrically insulating surface, a sheet-like shape and flat surface. For example, soda-lime glass, quartz glass, polyethylene terephthalate (PET) polyethylene naphthalate (PEN), cycloolefin polymers, polyimides (PI), polyethersulfones (PES), polymethyl methacrylate (PMMA), polycarbonates (PC), and polyarylates can be used. Further, a conductive or semiconductive substrate such as a stainless steel sheet, an aluminum foil, a copper foil, and a silicon wafer can be also used as an insulating substrate, for example, after they have been coated or laminated with a polymer material or a metal oxide. In addition, a surface-treated layer such as a layer with good adhesive properties may be formed on the insulating substrate surface, or the insulating substrate may be subjected to surface treatment such as a corona discharge treatment, a plasma treatment, and an UV/ozone treatment.

A gate electrode 20, a source electrode 40, and a drain electrode 50 can be formed by producing a film of a metal such as Al, Cr, Mo, Cu, Au, Pt, Pd, Fe, Mn, and Ag by an appropriate method such as PVD, CVD, or plating, and then using a well-known method such as photolithography. Further, a strongly doped semiconductor such as silicon can be also used. In addition, well-known transparent conductive materials such as indium tin oxide (ITO), fluorine-doped oxide (FTO), aluminum-doped zinc oxide (AZO), and gallium-doped zinc oxide (GZO), or well-known organic conductive materials such as PEDOT: PSS, polyanilines, polythiophenes can be also used, but in the case a comparatively high wiring resistance is obtained when these are used, it is preferred that the resistance be reduced.

The electrodes can be also formed by coating or printing with a solution, a paste or a nanoparticle dispersion of the above-described conductive materials such as metals, transparent oxides, and organic conductive polymers, or precursors thereof, followed by drying, baking, and photocuring or aging. The printing method used is not particularly limited, but from the standpoint of facilitating the process, reducing cost, and increasing the process rate, it is more preferred that a printing method in which patterning can be performed, such as relief printing, flexo printing, gravure printing, planographic printing, reverse offset printing, screen printing, ink jet printing, thermal transfer printing, or dispenser printing, be used. Further, a combination of spin coating, die coating, microgravure coating, dip coating, and the like with a patterning method such as photolithography may be also used. The above-described printing methods may be also used in combination.

When the source electrode 40 and drain electrode 50 are formed, in the case of a bottom-contact structure such as shown in FIG. 3, the semiconductor 60 is formed after the source electrode 40 and drain electrode 50 have been formed. Further, in the case of a top-contact structure such as shown in FIG. 4, the source electrode 40 and drain electrode 50 are formed after the semiconductor 60 has been formed.

An organic polymer such as polyvinylphenol (PVP), polystyrene (PS), polymethyl methacrylate (PMMA), polyvinyl alcohol (PVA), polyvinyl chloride (PVC), polyvinylidene fluoride (PVDF), polytetrafluoroethylene (PTFE), polyimides (PI), epoxy resins, polydimethylsiloxane (PDMS), and butadiene rubbers can be used for the gate insulating layer 30, but these polymers are not limiting, provided that a thin film with a thickness of 1 μm or less that has sufficient insulating properties can be formed. Further, a mixture of these polymers maybe used, and the insulating layer may be formed by coating and curing after mixing with a compound having a reactive substituent such as an alkoxysilane group, a vinyl group, an acrylic acid ester, and an epoxy group.

A well-known wet coating method such as a microgravure coating method, a dip coating method, a screen coating method, a die coating method, and a spin coating method can be used as methods for forming these organic polymer layers. The organic polymer layer may be subjected to surface treatment such as a corona discharge treatment, a plasma treatment, and an UV/ozone treatment, but care should be taken to prevent the surface from being roughened by the treatment. It is preferred that Ra or RMS of the surface of these organic polymer layers is 0.5 nm or less.

Further, oxides such as silicon oxide, titanium oxide, tantalum oxide, aluminum oxide, niobium oxide, zirconium oxide, copper oxide, and nickel oxide, which are inorganic oxides, and perovskites such as SrTiO₃, CaTiO₃, BaTio₃, MgTiO₃, and SrNb₂O₆, or composite oxides or oxide mixtures thereof can be also used for the gate insulating layer 30, but these compounds are not limiting, provided that an insulating film with a thickness of 1 μm or less and sufficient insulating properties can be formed.

Vapor film deposition methods such as a vacuum evaporation method, a sputtering method, ion plating, and CVD can be used as methods for forming these inorganic oxide layers. Further, plasma using any gas, an ion gun, or a radical gun may be additionally used in the film deposition process. The layer may be formed by reacting precursors of these metal oxides, more specifically, metal halides such as chlorides and bromides, or metal alkoxides and metal hydroxides with an alcohol, an acid such as hydrochloric acid, sulfuric acid, and nitric acid in water, or a base such as sodium hydroxide and potassium hydroxide and performing hydrolysis.

When such solution-system process is used, a well-known coating method such as a microgravure coating method, a dip coating method, a screen coating method, a die coating method, and a spin coating method can be used. The aforementioned inorganic oxide layers may be subjected to surface treatment such as a corona discharge treatment, a plasma treatment, and an UV/ozone treatment, but care should be taken to prevent the surface from being roughened by the treatment. It is preferred that Ra or RMS of the surface of these inorganic oxide layers is 0.5 nm or less.

The above-described organic polymers or inorganic oxides may be used individually, or in a mixture, or as a laminate.

When the self-assembled monolayer film in accordance with the present invention is formed on the surface of the gate insulating layer 30, it is preferred that the surface of the gate insulating layer 30 be hydrophilized to a contact angle with pure water of 10° or less by a surface treatment for hydrophilization, such as a corona discharge treatment, a plasma treatment, an UV/ozone treatment, or an acid or base treatment, and then coated with the above-described solution or immersed therein. When a surface treatment is performed on the surface of the gate insulating layer 30, it is preferred that a procedure be selected such that causes minimal roughening of the surface by etching or sputtering.

π-Conjugated organic polymers having semiconductor properties, for example, polypyrroles, polythiophenes, polyanilines, polyallylamines, polyfluorenes, polycarbazoles, polyindoles, and poly(p-phenylenevinylenes), or low-molecular substances having a π-conjugated system, for example, polycyclic aromatic derivatives such as pentacene, phthalocyanine derivatives, perylene derivatives, tetrathiafulvalene derivatives, tetracyanoquinodimethane derivatives, fullerenes, and carbon nanotubes can be used as the semiconductor 60, but this list is not limiting.

The semiconductor 60 in accordance with the present invention can be formed by a vacuum vapor deposition method or a printing method using a solution. When a printing method is used, no particular limitation is placed thereon. Thus, relief printing, flexo printing, gravure printing, planographic printing, reverse offset printing, screen printing, ink jet printing, thermal transfer printing, or dispenser printing, spin coating, die coating, microgravure coating, dip coat, and the like can be used, and the above-described printing methods may be also used in combination.

In the present embodiment, a field-effect transistor in which a self-assembled monolayer film is provided on the surface of an insulating layer is described byway of example, but a variety of structures using the self-assembled monolayer film can be also obtained by employing the method for forming a self-assembled monolayer film in accordance with the present invention.

Examples of such structures include a structure obtained by a photolithography method by using the self-assembled monolayer film as a resist material and a structure having a biosensing layer, a chemical sensing layer, or an antifouling layer containing the self-assembled monolayer film, but this list is not limiting.

According to the present invention, it is possible to provide a method for forming a self-assembled monolayer film that can form the film from a more typical material that is easy to procure, can form the film within a short interval, without using vacuum or high temperature, and has good reproducibility. It is also possible to improve charge transfer performance of a field-effect transistor by disposing a self-assembled monolayer film obtained by this method on an insulating layer of a field-effect transistor.

### EXAMPLES

The present invention will be described below in greater details based on specific examples thereof, but these examples serve merely to illustrate the invention and the present invention is not limited thereto.

### Example 1

A 5-inch n-type doped silicon wafer provided with a 300 nm thermal oxidation film was immersed for 30 min in a piranha solution (a mixed solution containing concentrated sulfuric acid and 30% aqueous hydrogen peroxide at a 7:3 ratio), washed thoroughly with pure water, subjected to UV/ozone treatment for 10 min, and washed again in pure water flow to obtain a washed hydrophilic SiO₂ film on a silicon wafer. The SiO₂ film surface was well dried by blowing nitrogen gas. The contact angle of pure water on the SiO₂ film surface was 3°.

A 3 mmol/L trichloroethylene solution of octadecyltrimethoxysilane was prepared, and the solution was coated to cover completely the substrate surface as prepared above, followed by spinning for 30 sec at 3000 rpm with a spin coater. The substrate obtained was placed into a sealable glass container, a small glass bottle containing 1 mL of concentrated hydrochloric acid was also placed in the glass container, and the glass container was tightly closed. After 12 h at room temperature, the substrate was taken out and ultrasonically washed with pure water and toluene to obtain a self-assembled monolayer film of octadecyltrimethoxysilane on the silicon wafer provided with a thermal oxidation film. The obtained self-assembled monolayer film had a mean square surface roughness (obtained by AFM observations) RMS of 0.09 Å and a contact angle of pure water of 108°.

### Example 2

The surface of a 5-inch n-type doped silicon wafer provided with a 300 nm thermal oxidation film was washed and treated by the same method as in Example 1.

A 6 mmol/L trichloroethylene solution of octadecyltrichlorosilane was prepared, and the solution was dropped by 10 mL within 20 sec, while rotating the substrate at 3000 rpm. The substrate obtained was ultrasonically washed with pure water and toluene to obtain a self-assembled monolayer film of octadecyltrichlorosilane on the silicon wafer provided with a thermal oxidation film.

The obtained self-assembled monolayer film had a mean square surface roughness (obtained by AFM observations) RMS of 0.09 Å and a contact angle of pure water of 106°.

### Example 3

The surface of a 5-inch n-type doped silicon wafer provided with a 300 nm thermal oxidation film was washed and treated by the same method as in Example 1.

A 3 mmol/L trichloroethylene solution of 11-phenoxyundecyltrimethoxysilane was prepared, and the solution was coated to cover completely the substrate surface as prepared above, followed by spinning for 30 sec at 3000 rpm with a spin coater. The substrate obtained was placed into a sealable glass container, a small glass bottle containing 1 mL of concentrated hydrochloric acid was also placed in the glass container, and the glass container was tightly closed. After 12 h at room temperature, the substrate was taken out and ultrasonically washed with pure water and toluene to obtain a self-assembled monolayer film of 11-phenoxyundecyltrimethoxysilane on the silicon wafer provided with a thermal oxidation film.

The obtained self-assembled monolayer film had a mean square surface roughness (obtained by AFM observations) RMS of 0.10 Å and a contact angle of pure water of 98°.

### Example 4

A film of polyvinylphenol (PVP) was formed to a thickness of 800 nm on PEN with a thickness of 100 μm by spin coating a cyclohexanone solution. The PVP surface was subjected to UV/ozone treatment for 10 min and washed again in pure water flow to obtain a hydrophilic surface. The PVP surface was well dried by blowing nitrogen gas. The contact angle of pure water on the PVP surface was 10°.

A 3 mmol/L trichloroethylene solution of octadecyltrimethoxysilane was prepared, and the solution was coated to cover completely the substrate surface as prepared above, followed by spinning for 30 sec at 3000 rpm with a spin coater. The substrate obtained was placed into a sealable glass container, a small glass bottle containing 1 mL of an aqueous solution of ammonium hydroxide was also placed in the glass container, and the glass container was tightly closed. After 12 h at room temperature, the substrate was taken out and ultrasonically washed with pure water and toluene to obtain a self-assembled monolayer film of octadecyltrimethoxysilane on PVP thin film of a PEN substrate.

The obtained self-assembled monolayer film had a mean square surface roughness (obtained by AFM observations) RMS of 0.32 Å and a contact angle of pure water of 101°.

### Example 5

A field-effect transistor of a bottom-gate and top-contact type was fabricated using the silicon wafer provided with the self-assembled monolayer film obtained in Example 1. A pentacene film with a thickness of 40 nm was formed as a semiconductor 60 by a vacuum vapor deposition method on the obtained self-assembled monolayer film of octadecyltrimethoxysilane, a mask was placed on the obtained pentacene thin film, and a gold film with a thickness of 40 nm was formed by a vacuum vapor deposition method to form an electrode pattern composed of source and drain electrodes 40, 50, thereby fabricating a field-effect transistor of a bottom-gate and top-contact type.

A transistor characteristic (Vg−Id characteristic; Vg: gate voltage, Id: drain current) of the field-effect transistor obtained in the above-described manner was measured. The mobility reached 3.2 cm²/Vs, the on/off ratio of the current value was 10⁶, and the threshold voltage was −5 V.

### Comparative Example 1

The surface of a 5-inch n-type doped silicon wafer provided with a 300 nm thermal oxidation film was washed and treated by the same method as in Example 1.

The substrate and 1 mL of octadecyltrimethoxysilane were placed into a small glass bottle, the glass bottle was then placed into a vacuum container made from glass, the pressure inside the system was reduced, and the vacuum container was air-tight closed. The entire content of the system was maintained for 12 h at 90° C., and a film was formed by a vacuum vapor deposition method. The substrate was taken out and ultrasonically washed with pure water and toluene to obtain a self-assembled monolayer film of octadecyltrimethoxysilane on the silicon wafer provided with a thermal oxidation film.

The obtained self-assembled monolayer film had a mean square surface roughness (obtained by AFM observations) RMS of 0.14 Å and a contact angle of pure water of 99°.

### Comparative Example 2

A pentacene thin film and source and drain electrodes were formed using the same method as in Example 5 by employing the silicon wafer provided with a self-assembled monolayer film that was obtained in Comparative Example 1 and a field-effect transistor of a bottom-gate and top-contact type was fabricated.

A transistor characteristic (Vg−Id characteristic; Vg: gate voltage, Id: drain current) of the field-effect transistor obtained in the above-described manner was measured. The mobility was 0.8 cm²/Vs, the on/off ratio of the current value was 10⁵, and the threshold voltage was −7 V.

### Comparative Example 3

The surface of a 5-inch n-type doped silicon wafer provided with a 300 nm thermal oxidation film was washed and treated by the same method as in Example 1.

The substrate was immersed in a 5 mmol/L toluene solution of octadecyltrimethoxysilane and allowed to stay for 3 h at room temperature. Here, the dielectric constant of toluene is 2.38. The substrate was taken out and ultrasonically washed with pure water and toluene to obtain a self-organized monomolecular film of octadecyltrimethoxysilane on the silicon wafer provided with a thermal oxidation film.

The obtained self-assembled monolayer film had a mean square surface roughness (obtained by AFM observations) RMS of 0.65 Å and a contact angle of pure water of 102°.

### Comparative Example 4

A pentacene thin film and source and drain electrodes were formed using the same method as in Example 5 by employing the silicon wafer provided with a self-assembled monolayer film that was obtained in Comparative Example 3 and a field-effect transistor of a bottom-gate and top-contact type was fabricated.

A transistor characteristic (Vg−Id characteristic; Vg: gate voltage, Id: drain current) of the field-effect transistor obtained in the above-described manner was measured. The mobility was 0.05 cm²/Vs, the on/off ratio of the current value was 10⁴, and the threshold voltage was −12 V.

The method for forming a self-assembled monolayer film in accordance with the present invention can provide a dense and smooth self-assembled monolayer film on the surface of metal oxides or polymer materials in a very easy manner within a short interval, at a low cost, and with good reproducibility. Therefore, this method is effective in any field using self-assembled monolayer films. For example, it can be used in photolithography employing a self-organized monomolecular film as a resist material, in a biosensing layer, a chemical sensing layer, an antifouling layer, and an insulating layer of a field-effect transistor (FET) containing a self-assembled monolayer film.

Where the self-assembled monolayer film obtained by the formation method in accordance with the present invention is used on the surface of an insulating layer of a field-effect transistor (FET), in particular an organic field-effect transistor (OFET) using an organic semiconductor, a gate insulating layer having an excellent surface smoothness and surface energy is provided in an easy manner within a short time and with good reproducibility on the FET insulating layer and excellent charge transfer performance is imparted to the FET. Therefore, the self-assembled monolayer film can be used in display elements such as LCD, organic EL, and electron paper having a FET array of FET-containing active matrix type as a TFT backplane. In particular, where an organic semiconductor is used, the self-assembled monolayer film can be used in display elements of flexible displays that employ specific features of organic semiconductors that can be formed by printing or vapor deposition at a low temperature.

What is claimed is:

1. A method for forming a self-assembled monolayer film, comprising at least:
dissolving an alkylsilane compound having at least an alkoxysilane group or a chlorosilane group at one end of a molecule in an organic solvent having a dielectric constant of 3.0 or more to 6.0 or less to obtain a solution;
subsequently coating the solution on a substrate or immersing the substrate into the solution; and
subsequently drying the solution located on the substrate.

2. The method for forming a self-assembled monolayer film according to claim 1, comprising hydrophilizing a surface of the substrate prior to the coating the solution.

3. The method for forming a self-assembled monolayer film according to claim 1, comprising exposing the dried surface to an acidic or basic gas after the drying the solution.

4. The method for forming a self-assembled monolayer film according to claim 1, wherein the number of carbon atoms in an alkyl chain of the alkylsilane compound is equal to or more than 10.

5. The method for forming a self-assembled monolayer film according to claim 1, wherein an alkyl chain length of the alkylsilane compound is equal to or more than 12 Å.

6. The method for forming a self-assembled monolayer film according to claim 1, wherein the alkylsilane compound is octadecyltrichlorosilane or octadecyltrimethoxysilane.

7. The method for forming a self-assembled monolayer film according to claim 1, wherein the organic solvent includes at least any one of trichloroethylene, chloroform, diethylether, and anisole.

8. The method for forming a self-assembled monolayer film according to claim 1, wherein the drying the solution is using a spin coater.

9. The method for forming a self-assembled monolayer film according to claim 1, wherein the coating the solution and the drying the solution are using a spin coater.

10. A structural body having a self-assembled monolayer film formed by the method for forming a self-assembled monolayer film described in claim 1.

11. A field-effect transistor in which a self-assembled monolayer film formed by the method for forming a self-assembled monolayer film described in claim 1 is provided on a surface of an insulating layer.
